(19) United States
(12) Patent Application Publication
(10) Pub. No.: US 2009/0232356 A1
(43) Pub. Date: Sep. 17, 2009

(54) Tracking System and Method for Tracking Objects

(76) Inventor: Deanna Schwartz, Saint Petersburg, FL (US)

Correspondence Address: JAY M. SCHLOFF;INTELLIPEX PLLC, 30200 TELEGRAPH RD, SUITE 245, BINGHAM FARMS, MI, 48025, US

(21) Appl. No.: 12/048,590

(22) Filed: Mar. 14, 2008

(51) Int. Cl. G06K 9/00

(52) U.S. Cl. 382/103

(57) ABSTRACT

Disclosed are tracking system and a method for locating a plurality of objects. The tracking system includes an identification module, a receiver, a processing module, and a transmitter. The identification module is configured to obtain unit identification information associated with the one or more traceable units. The receiver is configured to receive an information of a spatial location and unit identification information of the one or more traceable units. The processing module is electronically coupled to the identification module and the receiver and is configured to identify the one or more traceable units based on the obtained unit identification information and the received unit identification information. The processing module is further configured to determine locations of the one or more traceable units based on the information of the spatial location of the one or more identified traceable units. The transmitter is electronically coupled to the processing module.

### FIELD OF THE INVENTION

The present invention relates generally to tracking mechanisms, and, more particularly, to a system and method for tracking objects such as people.

### BACKGROUND OF THE INVENTION

Nowadays, news items reporting about persons disappearing are on rise. For example, persons may disappear after being abducted, or while participating in outdoor sport activities. Ironically, people that disappear during such outdoor activities, such as adventure sports, often remain unnoticed. This may be attributed to the fact that method currently being used for confirming a person's presence or absence is usually based on manual counting. As manual counting is susceptible to human errors, the probability of missing people increases.

Additionally, during abductions related to children, parents of the child only come to know about the abduction after the child is abducted. Of course, once parents discover that the child is missing, they start looking for the child. Accordingly, parents need to continuously monitor the children.

Currently, various tracking systems are commonly being used by the parents. For example, a GPS system may be utilized for tracking a location of the abducted child or any other person. However, these systems are utilized only after the parents realize that the child is missing, thereby delaying the process of tracking the child. Additionally, the current tracking systems are complex and costly.

Accordingly, there is a need of a tracking system that is capable of continuously monitoring people and that has reduced response time. Additionally, there is a need of a tracking system that is less complex and economical.

### SUMMARY OF THE INVENTION

In view of the foregoing disadvantages inherent in the prior art, the general purpose of the present invention is to provide a tracking system configured to include all the advantages of the prior art, and to overcome the drawbacks inherent therein.

Accordingly, an object of the present invention is to provide a tracking system that is capable of continuously monitoring people and that has reduced response time.

Another object of the present invention is to provide a tracking system that is easy to operate and economical.

Still another object of the present invention is to provide a tracking system for use in tracking one or more users.

In light of the above objects, in one aspect of the present invention, a tracking system for locating one or more traceable units is disclosed. The one or more traceable units may be held by one or more objects, for example, persons. The tracking system includes an identification module, a receiver, a processing module, and a transmitter. The identification module is configured to obtain unit identification information associated with the one or more traceable units. The receiver is configured to receive an information of a spatial location of the one or more traceable units and unit identification information of the one or more traceable units transmitted by the one or more traceable units. The processing module is electronically coupled to the identification module and the receiver. The processing module is configured to identify the one or more traceable units based on the obtained unit identification information and the received unit identification information. The processing module is further configured to determine locations of the one or more traceable units based on the information of the spatial location of the one or more identified traceable units. The transmitter is electronically coupled to the processing module. The transmitter is configured to transmit notification information to the one or more traceable units based on the locations of the one or more traceable units.

In another aspect of the present invention, a traceable unit capable of communicating with a tracking system is disclosed. The traceable unit includes a memory module, a processing module, a transmitter and a receiver. The memory module is capable of storing unit identification information associated with the traceable unit. The unit identification information enables the tracking system to identify the traceable unit. The processing module is configured to identify a spatial location of the traceable unit. The transmitter is electronically coupled to the processing module and the memory module. The transmitter is further configured to transmit the unit identification information associated with the traceable unit. The transmitter is configured to transmit information of the spatial location of the traceable unit. The information of the spatial location of the traceable unit enables the tracking system to determine a location of the traceable unit. The receiver is electronically coupled to the processing module. The receiver is configured to receive a notification information from the tracking system based on the location of the traceable unit.

In yet another aspect of the present invention, a method for locating one or more traceable units is disclosed. The method includes obtaining unit identification information associated with one or more traceable units for communicably coupling the tracking system and the one or more traceable units. Further, the method includes receiving information of a spatial location of the one or more traceable units and unit identification information associated with the one or more traceable units from the one or more traceable units when the tracking system is communicably coupled with the one or more traceable units. Moreover, the method includes identifying the one or more traceable units based on the obtained unit identification information and the received unit identification information. Further, the method includes determining a location of the one or more traceable units based on the information of the spatial location of the one or more traceable units. Still further, the method includes transmitting notification information to the each of the one or more traceable units based on the determined location of the each of the one or more traceable units.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 illustrates an exemplary environment in which a tracking system communicates with one or more traceable units;

FIG. 2 illustrates a block diagram of the tracking system of FIG. 1, in accordance with an embodiment of the present invention;

FIGS. 3A, 3B and 3C illustrate a perspective view, a side view and a front view of an exemplary tracking device incorporating the tracking system of FIGS. 1 and 2, in accordance with an embodiment of the present invention;

FIG. 4 illustrates a block diagram of a traceable unit capable of being tracked by the tracking system of FIG. 1, in accordance with an embodiment of the present invention;

FIG. 5 illustrates an exemplary device incorporating the traceable unit of FIG. 4, in accordance with an embodiment of the present invention; and

FIG. 6 illustrates a flowchart depicting a method for locating a plurality of objects, in accordance with an embodiment of the present invention.

Like reference numerals refer to like parts throughout the description of several views of the drawings.

### DETAILED DESCRIPTION OF THE INVENTION

The exemplary embodiments described herein detail for illustrative purposes are subject to many variations in structure and design. It should be emphasized, however, that the present invention is not limited to a tracking system and method for locating a plurality of objects, as shown and described. It is understood that various omissions and substitutions of equivalents are contemplated as circumstances may suggest or render expedient, but these are intended to cover the application or implementation without departing from the spirit or scope of the claims of the present invention.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item.

The present invention provides a tracking system and method for locating plurality of objects. The present invention further provides a traceable unit capable of being tracked by the tracking system. The traceable unit may be held by an object. Accordingly, the present invention facilitates determination of location of the object holding the traceable unit by using the tracking system.

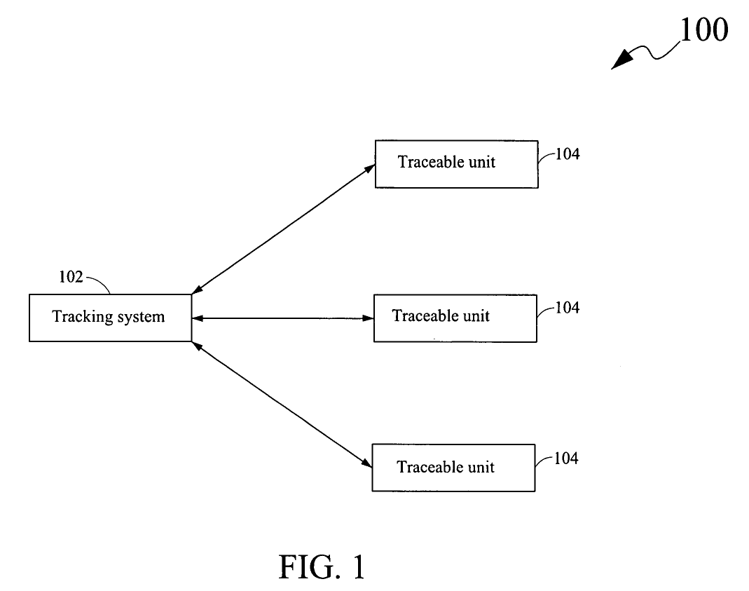

Referring to FIG. 1, an exemplary environment 100 where the present invention may be practiced is illustrated. More specifically, FIG. 1 illustrates a tracking system 102 communicably coupled to one or more traceable units 104 (hereinafter called as the traceable units 104). The tracking system 102 communicates with the traceable units 104 using a radio frequency technology. However, it will be apparent to a person skilled in the art that the tracking system 102 may be capable of communicating with the traceable units 104 using any other communication technologies known in the art.

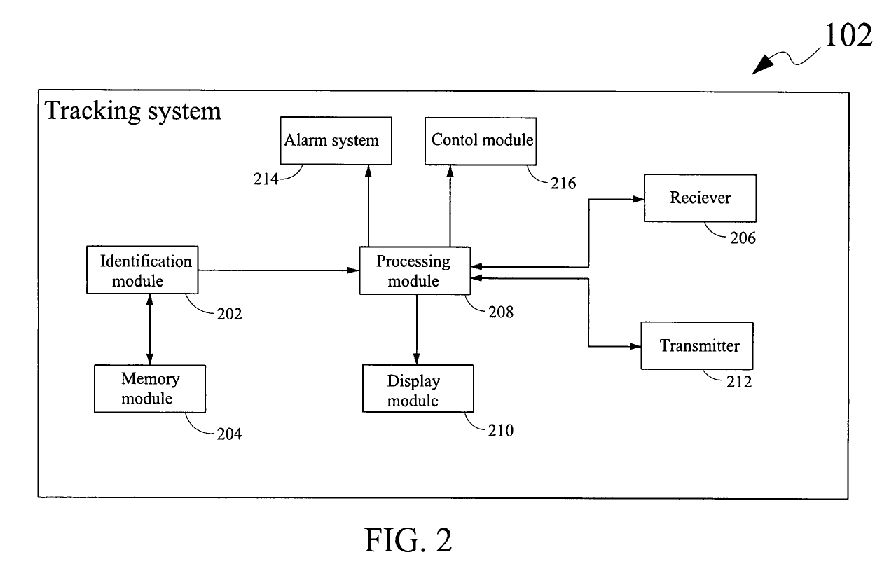

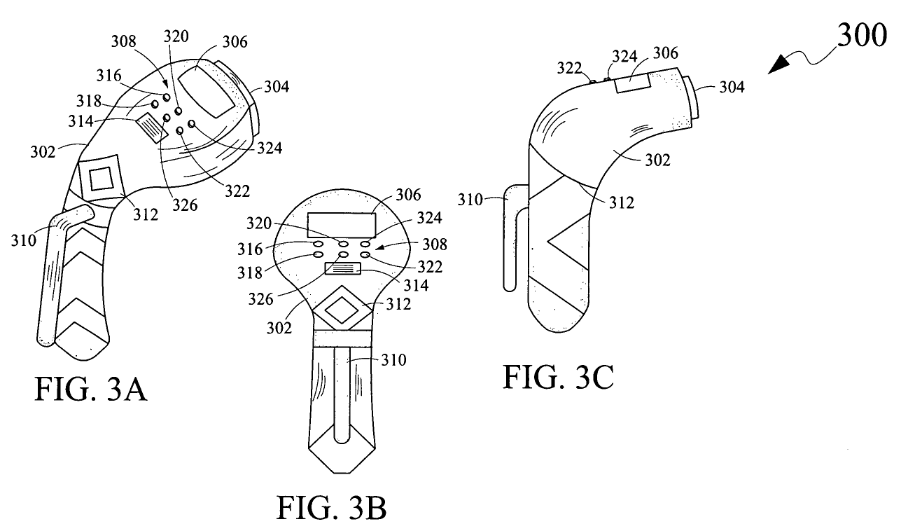

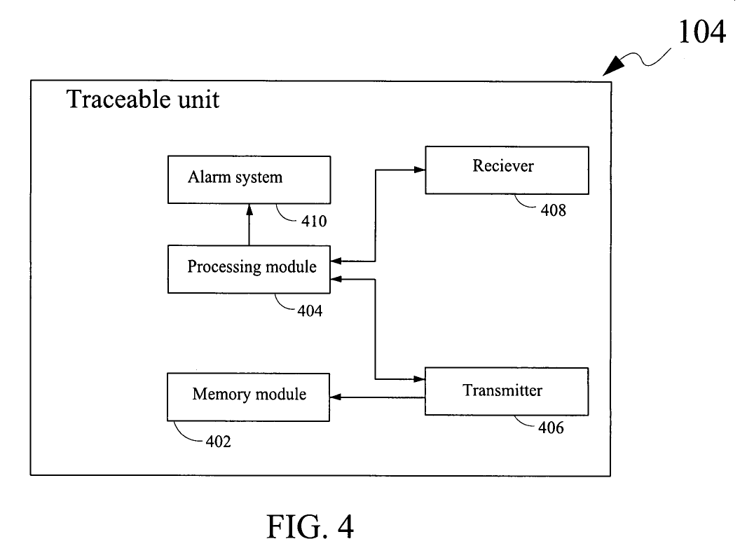

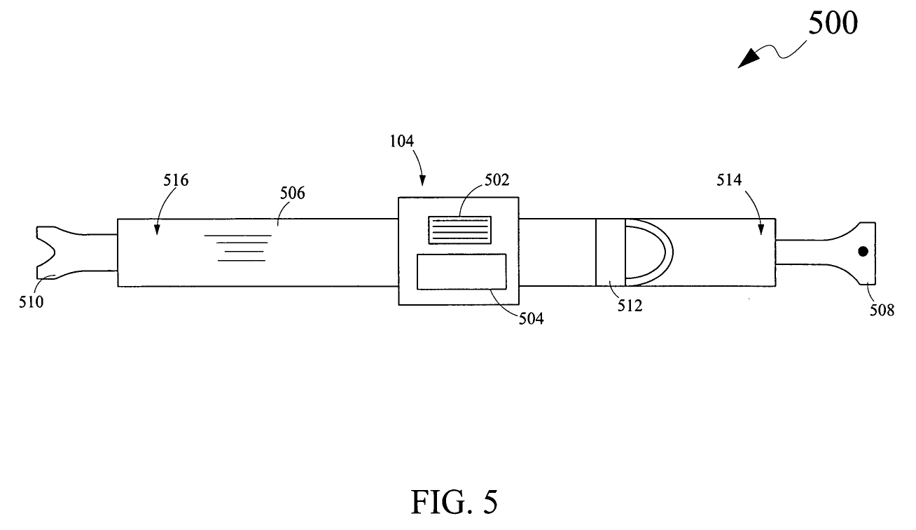

In particular, the tracking system 102 is capable of registering the traceable units 104 therewith. Thereafter, the tracking system 102 utilizes the registration information associated with the traceable units 104 for determining the location of the traceable units 104, thereby tracking the traceable units 104. More specifically, the tracking system 102 is capable of receiving the information of the spatial locations of the traceable units 104. Based on the information of the spatial locations of the traceable units 104, the tracking system 102 determines locations of the traceable units 104 to locate the one or more user holding the traceable units 104. The tracking system 102 will be explained further in conjunction with FIGS. 2 and 3. Further, a traceable unit of the traceable units 104 will be explained further in conjunction with FIGS. 4 and 5.

FIG. 2 illustrates the tracking system 102 of FIG. 1 for locating one or more traceable units such as traceable units 104, in accordance with an embodiment of the present invention. The tracking system 102 includes an identification module 202, a memory module 204, a receiver 206, a processing module 208, a display module 210, a transmitter 212, an alarm system 214 and a control module 216. The identification module 202 is configured to obtain unit identification information associated with the traceable units 104 during a registration stage. More specifically, during the registration stage, the tracking system 102 may read the unit identification information such as a plurality of barcode numbers corresponding to the traceable units 104, thereby registering the traceable units 104 with the tracking system 102. The unit identification information obtained during the registration stage hereinafter may be referred to as ‘obtained unit identification information’. The obtained unit identification information enables the tracking system 102 to communicate with the traceable units 104. The traceable units 104 may be held by one or more objects such as human beings, animals, and so on.

In one embodiment of the present invention, the identification module 202 stores the unit identification information in a memory module, such as the memory module 204 of the tracking system 102. The unit identification information enables the identification module 202 to identify the traceable units 104 based on the unit identification information.

The receiver 206 is configured to receive the unit identification information of the traceable units 104. The unit identification information received by the receiver 206 may be hereinafter referred to as ‘received unit identification information’. The receiver 206 is further configured to receive information of spatial locations of the traceable units 104. The information of the spatial locations and the unit identification information of the traceable units 104 are transmitted by the traceable units 104. The information of the spatial locations of the traceable units 104 may include for example, latitudinal and longitudinal positions of an area of the locations of the traceable units 104.

The processing module 208 is electronically coupled to the identification module 202 and the receiver 206. The processing module 208 may be configured to identify the traceable units 104 based on the obtained identification information and the received identification information. For example, the processing module 208 may be configured to read a bar code number of a traceable unit, for example the traceable unit 104, thereby enabling the tracking system 102 to identify the traceable unit 104. The processing module 208 is further configured to determine locations of the traceable units 104 based on the information of the spatial locations of the identified traceable units 104.

The display module 210 is operatively coupled to the processing module 208. The display module 210 is capable of displaying the locations of the identified traceable units 104 determined by the processing module 208. For instance, the display module 210 may display the locations of the traceable units 104 in a geographical map of the particular area where the traceable units 104 are located, based on the latitudinal and longitudinal locations of the traceable units 104.

In one embodiment of the present invention, the processing module 208 may be further configured to determine whether the locations of the traceable units 104 are beyond a predefined distance from the tracking system 102. The value of the predefined distance may be stored in the memory module 204 during the registration stage. In one embodiment of the present invention, the predefined distance may be associated with the obtained unit identification information of the traceable units 104 stored in the memory module 204. This enables the processing module 208 to identify the predefined distance associated with the obtained unit identification information of the traceable units 104, while determining whether the locations of the traceable units 104 are beyond a predefined distance from the tracking system 102.

The transmitter 212 is electronically coupled to the processing module 208 and is configured to transmit the notification information to the traceable units 104 based on the spatial locations of the traceable units 104. More specifically, when the traceable units 104 are located beyond the predefined distance from the tracking system 102, the processing module 208 sends notification information to the traceable units 104. For instance, when the one or more objects holding the traceable units 104 moves beyond the predefined distance from the tracking system 102, the tracking system 102 sends the notification information to the traceable units 104. The notification information may be, for example, warning information sent to the traceable units 104.

In one embodiment of the present invention, the processing module 208 may initiate the tracking system 102 to generate alarm signals when the traceable units 104 are located beyond the predefined distance from the tracking system 102. Accordingly, the alarm system 214 operatively coupled to the processing module 208 generates one or more alarm signals when the traceable units 104 are located beyond the predefined distance from the tracking system 102. In one embodiment of the present invention, the alarm system 214 may activate one or more sound generating device such as one or more speakers for generating alarm sounds to notify the user holding the tracking system 102. For instance, during a sports activity such as trekking, a leader guiding a trekking team may hold the tracking system 102, and each of the team member may hold the traceable units 104. The tracking system 102 may monitor the distance of each of the team member from the leader, and generate an alarming sound notifying the leader when a team member equipped with a traceable unit 104 has moved beyond a predefined distance from the leader.

It will be apparent to a person skilled in the art that the tracking system 102 may include any other alerting system also apart from the sound generating device. For example, the tracking system may activate multiple Light Emitting Diodes (LED's) capable of producing different colored lights for notifying the user thereof.

In one embodiment of the present invention, the tracking system 102 may be implemented as a counting device to determine whether any object from the one or more objects is missing. For instance, the tracking system 102 held by a leader of a group of tourists is used to enter the unit identification information associated with the traceable units 104 worn by the group of tourists. While entering the unit identification information, a number of tourists present in the group of tourists will be counted and stored in the tracking system 102. Thereafter, the group of tourists may be allowed by the leader to disperse to see sights, etc. Once, the group of tourists comes back to the leader, the tracking system 102 may be used to read the unit identification information associated with the traceable units 104 worn by the group of tourists, thereby confirming whether all the tourists of the group of tourists are present. If any tourist is identified as missing, the location of a traceable unit 104 worn by the missing tourist is displayed by the display module 208. Accordingly, the missing tourist may be located.

Further, the control module 216 may be adapted to control one or more operations of the tracking system 102. The control module 216 is operatively coupled to the processing module 208. Examples of one or more operations may include switching on/switching off the tracking system 102, operating the display module 210, and the like.

It will be evident to those skilled in the art that each of the modules of the tracking system 102 such as the identification module 202, the memory module 204, the processing module 208, the display module 210, and the control module 216 may be implemented as a hardware module, a software module, a firmware module, or any combination thereof. Furthermore, it will be obvious to those skilled in the art that the tracking system 102 may include requisite electrical or electronic connections for communicably coupling the various modules of the tracking system 102.

Referring to FIGS. 3A, 3B, and 3C, an exemplary tracking device 300 incorporating the tracking system 102 of FIGS. 1 and 2 is illustrated. The tracking device 300 includes a body 302, a scanning unit 304, a display unit 306, a plurality of control buttons 308, a fastener 310, a grip 312, and an alarm device 314 such as one or more speakers. The body 302 of the tracking device 300 is structured to enable a user to conveniently hold the tracking device 300.

The scanning unit 304 is configured to obtain the unit identification information associated with the traceable units 104. More specifically, the scanning unit 304 may be operatively coupled to the identification module 202 of the tracking system 102, thereby enabling the scanning unit 304 to obtain the unit identification information. The obtained unit identification information may be stored in the memory module 204 of the tracking system 102. In one embodiment of the present invention, the scanning unit 304 may read and store the unit identification information such as a plurality of barcode numbers, associated with traceable units 104. The identification module 202 may store the plurality of barcode numbers in the memory module 204 of the tracking system 102.

The tracking device 300 incorporating the tracking system 102 is capable of tracking the traceable units 104. The locations of the traceable units 104 may be displayed on the display unit 306. More specifically, the display unit 306 may be operatively coupled to the display module 210 of the tracking system 102. In one embodiment of the present invention, the display unit 306 may display the locations of the traceable units 104 in a geographical map of an area where the traceable units 104 are located.

The plurality of controlling buttons 306 is adapted to assist the user in operating the tracking system 102. More specifically, the plurality of control buttons 306 may be coupled to the control module 216. The plurality of controlling buttons 306 may include an on/off button 316, a back button 318, a scan-in button 320, an enter button 322, a scan-out button 324, a reset button 326, and the like. The on/off button 316 may enable the user to switch on or switch off the tracking system 102. The back button 318 may enable the user to move to any previous menu displayed in the display unit 306. Further, the scan-in button 320 may enable a user to enter the unit identification information associated with the traceable units 104. More specifically, the scan-in button 320 may be pressed to activate the scanning unit 304 for reading and storing the unit identification information associated with the traceable units 104. Further, the enter button 322 may enable the user to enter the unit identification information into the memory of the tracking system 102. Moreover, the scan-out button 324 may be operated for deleting the stored unit identification information. The reset button 326 may be operated to reset the tracking system 102.

The fastener 310 may be coupled to the body 302 of the tracking system 102. The fastener 310, such as a belt clip, may be adapted to enable the user in conveniently holding the tracking system 102. It will apparent to person skilled in the art that the fastener 310 may be any other type of fastener known in the art that may enable the user to conveniently hold the tracking system 102.

The grip 312 may be disposed on the body 302 of the tracking system 102. The grip 312 assists the user in firmly holding the tracking system 102. In one embodiment of the present invention, the grip 312 may be composed of a rubber material. However, it will be apparent to a person skilled in the art that the grip 312 may be composed of any other materials known in the art.

The alarm device 314 may be operatively coupled to the alarm system 214. Accordingly, the alarm device 314 may be activated based on instructions received from the alarm system 214 of the tracking system 102. The alarm device 314 incorporated in the tracking device 300 is shown to include one or more speakers for generating alarm sounds. However, it will be apparent to a person skilled in the art that the alarm device 314 may be any other device known in the art capable of generating alarming signals, for example, a visual signal, a vibration signal and the like.

In one embodiment of the present invention, the tracking device 300 may be water-proof. Accordingly, the tracking system 300 may be utilized inside a water body for tracking the object present therein. For example, the disclosed tracking system may be utilized for tracking people during water sports, such as scuba diving.

In one embodiment of the present invention, the tracking device 300 may further include a slot (not shown) capable of receiving any power supplying source such as batteries for operation of the tracking system 102. In another embodiment of the present invention, the tracking device 300 may be externally charged using a power source.

Referring to FIG. 4, a block diagram of the traceable unit 104 capable of being tracked by the tracking system 102 of FIGS. 1 and 2 is illustrated. The traceable unit 104 includes a memory module 402, a processing module 404, a transmitter 406, a receiver 408 and an alarm system 410. The memory module 402 is capable of storing the unit identification information associated with the traceable unit 104. The unit identification information enables the tracking system 102 to identify the traceable unit 104. In one embodiment of the present invention, the unit identification information is a barcode number.

The processing module 404 is configured to identify a spatial location of the traceable unit 104. Specifically, when an object holding the traceable unit 104 moves away from the tracking system 102, the processing module 404 continuously monitors the spatial location of the traceable unit 104 to identify a spatial location of the object. It will be apparent to a person skilled in the art that the processing module 404 may employ technology known in the art to continuously monitor the spatial location of the traceable unit 104.

The transmitter 406 is electronically coupled to the processing module 404 and memory module 402. The transmitter 406 is configured to transmit the unit identification information associated with the traceable unit 104. The unit identifications information transmitted by the traceable unit 104 enables the tracking system 102 to identify the traceable unit 104. The transmitter 406 is further configured to transmit information of the spatial location of the traceable unit 104 to the tracking system 102. The information of the spatial location of the traceable unit 104 enables the tracking system 102 to determine a location of the traceable unit 104. Accordingly, the tracking system 102 may determine a location of the object holding the traceable unit 104 based on the information of the spatial location of the traceable unit 104.

The traceable unit 104 includes the receiver 408 electronically coupled to the processing module 404. The receiver 408 is configured to receive the notification information from the tracking system 102 based on the location of the traceable unit 104. More specifically, when the object holding the traceable unit 104 moves beyond the predefined distance from the tracking system 102, the traceable unit 104 receives notification information from the tracking system 102. For example, the traceable unit 104 may be held by a child and the tracking system 102 may be held by a parent of the child for monitoring the child. When the child moves beyond a certain distance preset by the parent in the tracking system, the traceable unit 104 being held by the child may receive a notification information. The notification information may notify the child he/she has moved out of the said preset distance from the parent.

In one embodiment of the present invention, the notification information may be processed to activate the alarm system 410. The alarm system may be activated to generate one or more alarm signals based on the notification information. The notification information may indicate that the traceable unit 104 is located beyond the predefined distance from the tracking system 102 as mentioned previously. These alarm signals notifies the object holding the traceable unit 104 that the object has moved beyond the predefined distance from the tracking system 102.

In one embodiment of the present invention, the alarm system 410 may initiate one or more sound generating devices capable of generating the alarm signals such as the alarm sounds based on the notification information. The one or more sound generating device includes one or more speakers and the like. Other examples of the alarm signal may include, but are not limited to, a visual alarm, a vibration alarm, and the like.

It will be evident to those skilled in the art that each of the modules of the traceable unit 104 such as the memory module 402, the processing module 404, the transmitter 406, the receiver 408 and an alarm system 410 may be implemented as a hardware module, a software module, a firmware module, or any combination thereof. Furthermore, it will be obvious to those skilled in the art that the traceable unit 104 may include requisite electrical or electronic connections for communicably coupling the various modules of the traceable unit 104.

Referring to FIG. 5, an exemplary traceable device 500 incorporating the traceable unit 104 of FIG. 1 and FIG. 2 is illustrated. The exemplary traceable device 500 is structured for being conveniently held, more specifically tied to the object. Various components have been described in FIG. 4 except for the one or more sound generating devices 502 and a display section 504. The one or more sound generating devices 502 may include speakers.

The display section 504 displays the unit identification information associated with the traceable unit 104. In one embodiment of the present invention, the display section 504 may be a display slot provided on the traceable device 500. The display slot may display a barcode number associated with the traceable unit 104. In such an instance, the barcode number may be read and stored by the tracking system 102.

The traceable device 500 further includes a strap 506, and one or more fasteners such as a clasp 508 and a clip 510. The strap 506 includes an adjusting means 512, a first end portion 514 and a second end portion 516. The adjusting means 512 enables a user to adjust a length of the strap 506 according to the user's need. In one embodiment of the present invention, the strap 506 may be water-proof. Accordingly, the traceable device 500 may be utilized by users present in a water body. For example, the disclosed traceable device 500 may be utilized by people during under water sports, like scuba diving. It will be apparent to a person skilled in the art that the strap may be composed of any material such as a water resistant material known in the art.

The clasp 508 may be attached to the first end portion 514 of the strap 506 while the clip 510 may be attached to the second end portion 516 of the strap 506. The clasp 508 and the clip 510 enable the user to hold the traceable device 500 to a body portion of the user. More specifically, the clasp 508 may be detachably coupled with the clip 510 to enable the user to wear the traceable device 500 on to a wrist of the user. It will be apparent to a person skilled in the art that the one or more fasteners may be composed of any material known in the art. Further, it will be apparent to a person skilled in the art that the traceable device 500 may include any other type of fasteners known in the art for assisting the user to hold the traceable device 500 to the body thereof.

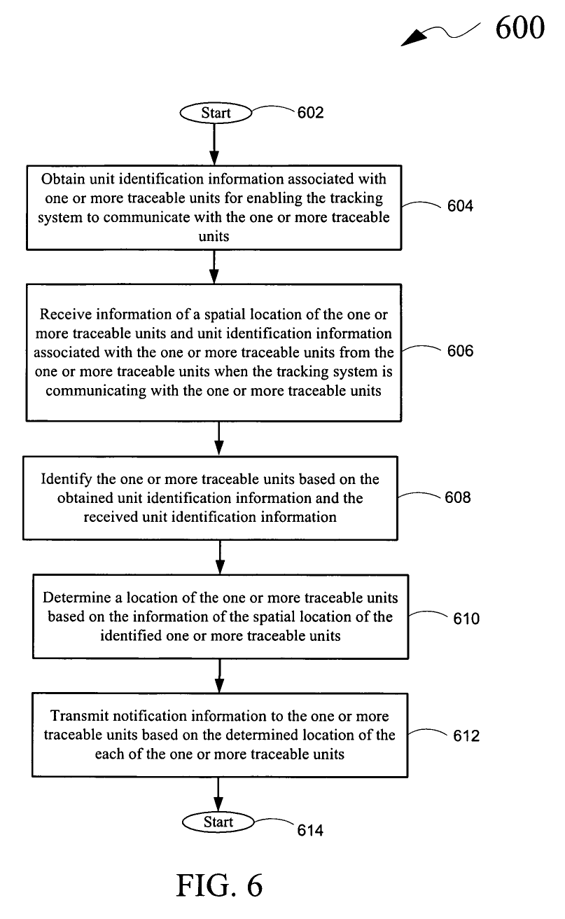

FIG. 6 illustrates a flowchart depicting a method 600 for locating one or more traceable units, for example, the traceable units 104 by a tracking system, for example, the tracking system 102. The method 600 starts at 602. A unit identification information associated with one or more traceable units is obtained by the tracking system 102 at 604. Example of the unit identification information may include, but is not limited to the barcode number associated with the traceable units 104. The tracking system 102 may receive the barcode information of the traceable units 104 by scanning the barcode number thereof. The barcode information may be stored by the tracking system 102 in the memory module 204 (FIG. 2).

The obtained unit identification information may enable the tracking system 102 to communicably couple with the traceable units 104. More specifically, the tracking system 102 receives an information of a spatial location of each of the traceable units 104 and unit identification information associated with the each of the traceable units 104 at 606.

The tracking system 102 identifies the traceable units 104 based on the obtained unit identification information and the received identification information at 608. More specifically, the processing module 208 (FIG. 2) of the tracking system 102 compares the received identification information with the obtained identification information stored in the memory module 204. Based on the comparison, the processing module 208 identifies the traceable units 104.

Thereafter, a location of the traceable units 104 is determined by the tracking system 102 based on the information of the spatial location of the each of the traceable units 104 at 610. The spatial location of the tracking system 102 may include the latitudinal location and the longitudinal location of the traceable units 104. Accordingly, based on the latitudinal location, and the longitudinal location of the traceable units 104, a geographical position of the traceable units 104 is identified. Moreover, the identified location of the traceable units 104 may be displayed on the tracking system 102.

Subsequently, a notification information is transmitted to the one or more traceable unit 104 based on the determined location of the one or more traceable units 104 at 612. More specifically, it is determined whether the determined location of the each of the traceable units 104 is beyond a predefined distance from the tracking system 102. The predefined distance may be a permissible distance that may be maintained between the traceable units 104 and tracking system 102. For example, the traceable unit 104 may be held by a child, and the tracking system 102 may be held by a parent. The parent may preset a distance up to which the child may move, thereby monitoring the child's activities within the said distance. Thereafter, the method terminates at 614.

The tracking system, the traceable unit, and the method explained in conjunction with FIGS. 1, 2, 3A, 3B, 3C, 4, 5 and 6 for locating a one or more traceable units may be advantageous to the users as the tracking system and traceable unit posses a higher response time. As a result, a child holding the traceable unit may be effectively tracked by a parent holding the tracking system. Further, the quicker response time of the tracking system and traceable unit enables the parent to locate the child within a short time period. In addition, the fasteners provided in the traceable unit are structured in manner so that when coupled to each other the fasteners may not be easily detached by children. As a result, probability of losing the traceable unit by the child may be reduced. Moreover, the tracking system and traceable unit may be water-proof, thereby enabling a usage thereof by people going for water sports for example, scuba divers, beach goers, and so on. Moreover, while swimming in the sea, a person may carry the tracking system for tracking other individuals holding the traceable unit. Additionally, the tracking system may be used as a counting device by user to determine whether any individual from a group of people engaged in various activities such as trekking, scuba diving, is missing. Further, the tracking system is capable of registering a departure and an arrival of each individual of the group of people and alerting the user if any individual is missing. In addition to the above, the tracking system is economical. Also, the tracking system has a compact structure, thereby enabling an easy portability thereof.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but these are intended to cover the application or implementation without departing from the spirit or scope of the claims of the present invention.

What is claimed is:

1. A tracking system for locating one or more traceable units, the tracking system comprising:
an identification module configured to obtain unit identification information associated with the one or more traceable units;
a receiver configured to receive
an information of a spatial location of the one or more traceable units, and
unit identification information of the one or more traceable units transmitted by the one or more traceable units;
a processing module electronically coupled to the identification module and the receiver, the processing module configured to
identify the one or more traceable units based on the obtained unit identification information and the received unit identification information, and
determine a location of the one or more traceable units based on the information of the spatial location of the one or more identified traceable units; and
a transmitter electronically coupled to the processing module, the transmitter configured to transmit notification information to the one or more traceable units based on the location of the one or more traceable units.

2. The tracking system of claim 1, wherein the unit identification information comprises one or more barcode numbers associated with the one or more traceable units.

3. The tracking system of claim 1, further comprising a memory module communicably coupled to the identification module, the memory module capable of storing the unit identification information associated with the one or more traceable units.

4. The tracking system of claim 1, further comprising an alarm system operatively coupled to the processing module, the alarm system capable of generating one or more alarm signals upon determining the location of the one or more traceable units being beyond a predefined distance from the tracking system.

5. The tracking system of claim 1, further comprising a control module operatively coupled to the processing module, the control module adapted to control one or more operations of the tracking system.

6. The tracking system of claim 1, further comprising a display module operatively coupled to the processing module, the display module capable of displaying the locations of the one or more traceable units determined by the processing module.

7. A traceable unit capable of communicating with a tracking system, the traceable unit comprising:
a memory module capable of storing unit identification information associated with the traceable unit, the unit identification information enabling the tracking system to identify the traceable unit;
a processing module configured to identify a spatial location of the traceable unit;
a transmitter electronically coupled to the processing module and the memory module, the transmitter configured to,
transmit the unit identification information associated with the traceable unit, and
transmit information of the spatial location of the traceable unit, wherein the information of the spatial location of the traceable unit enables the tracking system to determine a location of the traceable unit; and
a receiver electronically coupled to the processing module, the receiver configured to receive a notification information from the tracking system based on the location of the traceable unit.

8. The traceable unit of claim 7, wherein the unit identification information is a barcode number.

9. The traceable unit of claim 7, further comprising an alarm system operatively coupled to the processing module, the alarm system capable of generating one or more alarm signals upon determining the location of the traceable unit being beyond a predefined distance from the tracking system.

10. A method for locating one or more traceable units, the one or more traceable units capable of communicating with a tracking system, the method comprising:
obtaining unit identification information associated with one or more traceable units for communicably coupling the tracking system and the one or more traceable units;
receiving information of a spatial location of each of the one or more traceable units and unit identification information associated with the each of the one or more traceable units from the each of the one or more traceable units when the tracking system is communicably coupled with the one or more traceable units;
identifying the one or more traceable units based on the obtained unit identification information and the received unit identification information;
determining a location of the one or more traceable units based on the information of the spatial location of the identified one or more traceable units; and
transmitting notification information to the each of the one or more traceable units based on the determined location of the one or more traceable units.

11. The method of claim 10, further comprising displaying the determined location of the each of the one or more traceable units.

12. The method of claim 10, further comprising generating one or more alarm signals by the tracking system upon determining the one or more traceable units being located beyond a predefined distance from the tracking system.
